(19) United States
(12) Patent Application Publication
(10) Pub. No.: US 2021/0352189 A1
(43) Pub. Date: Nov. 11, 2021

(54) POWERS OF LASERS TO PRINT COLORS OF SECURITY PIXELS

(71) Applicant: Hewlett-Packard Development Company, L.P., Spring, TX (US)

(72) Inventors: Mark Q. Shaw, Boise, ID (US); Kyeongman Kim, Pangyo (KR); Jung Tag Gong, Pangyo (KR)

(73) Assignee: Hewlett-Packard Development Company, L.P., Spring, TX (US)

(21) Appl. No.: 16/972,051

(22) PCT Filed: Jan. 31, 2019
(86) PCT No.: PCT/US2019/016101

§ 371 Date: Dec. 4, 2020

(51) Int. Cl. H04N 1/32; B42D 25/41

(52) U.S. Cl. CPC H04N 1/32309; H04N 1/32304; B42D 25/41

(57) ABSTRACT

An example of a computer-readable medium storing machine-readable instructions. When executed, the machine-readable instructions may cause a processor to control a laser to print a test pattern. The test pattern may be scanned to determine visibility of pixels. The power of a laser may be adjusted based on the visibilities to print a security pixel.

### BACKGROUND

Printers may add security markings to printed documents. The markings may be created by modifying pixels within the image to print lighter or darker than surrounding pixels. The markings may be printed in a way to make them difficult to see by the unaided eye, but discernible with some image enhancement, such as magnification, increasing a contrast ratio, or overlay of a key to identify correlation marks. The security markings may allow the identification of a specific printer that printed the document.

### BRIEF DESCRIPTION OF THE DRAWINGS

Various examples will be described below referring to the following figures:

FIG. 1 shows a printer in accordance with various examples;

FIG. 2 shows a test pattern in accordance with various examples;

FIG. 3 shows a mixed color test pattern in accordance with various examples;

FIG. 4 shows a method of printing a test pattern and adjusting a laser based on visibility of pixels in the test pattern in accordance with various examples;

FIG. 5 shows a method of printing a test pattern and calculating security powers of a laser to print security pixels in accordance with various examples; and

FIG. 6 shows a method of printing test pixels and calculating security powers of a laser to print security pixels in accordance with various examples.

### DETAILED DESCRIPTION

Security markings, such as one composed of security pixels, may be included in printed documents from a printer. The security markings may include information about the identity of the printer or a date or time the printing occurred. Security pixels may be printed so as not to be visible to the unaided eye, but able to be seen with image enhancement. Determining the settings to use in printing security pixels may be challenging, and the settings may change as different colors are used and as the underlying document image changes. Settings for printing security pixels may be different when printing against a white background than when printing against a rainbow of colors.

Security pixels may be printed by adjusting the power of a laser used in laser printing. When the background is white or a light color, the power of the laser may be slightly increased to create a slightly darker pixel, or a light coloring may be added to the pixel. When the background is dark, the power of the laser may be slightly decreased to create a slightly lighter pixel. To determine the power settings to use, a test pattern may be printed that prints various test pixels at different power levels against different backgrounds. The test pattern may be scanned, and power levels determined based on the visibility of the test pixels.

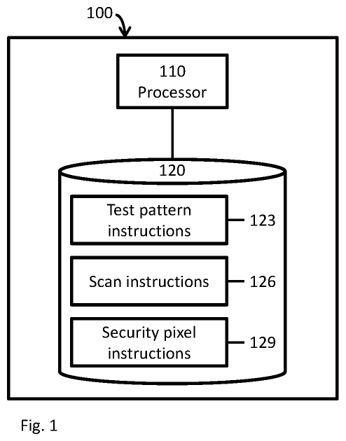

FIG. 1 shows a printer 100 in accordance with various examples. Printer 100 includes a processor 110 and storage 120. The storage 120 includes test pattern instructions 123, scan instructions 126, and security pixel instructions 129. The test pattern instructions 123, scan instructions 126, and security pixel instructions 129 may be instructions to perform the methods disclosed herein, such as the methods discussed in connection with other figures herein. The test pattern instructions 123, scan instructions 126, and security pixel instructions 129 may be executed by the processor 110.

The processor 110 may be coupled to the storage 120, such as via a bus. The processor 110 may comprise a microprocessor, a microcomputer, a microcontroller, a field programmable gate array (FPGA), or discrete logic. The processor 110 may execute machine-readable instructions that implement the methods described herein.

The storage 120 may include a hard drive, solid state drive (SSD), flash memory, electrically erasable programmable read-only memory (EEPROM), or random access memory (RAM).

The test pattern instructions 123 may include instructions to print a test pattern. The test pattern may include test pixels printed using different power settings of a laser. The test pixels may be printed against different backgrounds.

The scan instructions 126 may include instructions to scan the test pattern. The scan may be part of an in-line scan performed as the test pattern is being printed. The scan instructions may involve interaction by a user to transfer the test pattern to a scanner for scanning. The scanner may be integral to the printer or a separate device. If the scanner is a separate device, the scan instructions may include interfacing with the scanner or selecting a file from a scans folder.

The security pixel instructions 129 may include instructions to add security pixels to a document or image. The security pixel instructions may adjust the power of the laser used to print security pixels, causing the security pixels to print lighter or darker than the surrounding pixels in the document or image.

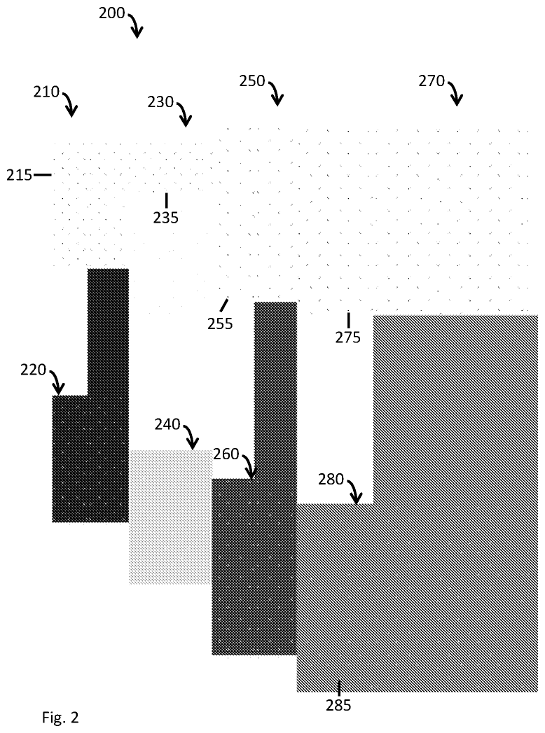

FIG. 2 shows a test pattern 200 in accordance with various examples. The test pattern 200 includes a black test pattern against a white background 210, a black test pattern against a black background 220, a yellow test pattern against a white background 230, a yellow test pattern against a yellow background 240, a magenta test pattern against a white background 250, a magenta test pattern against a magenta background 260, a cyan test pattern against a white background 270, and a cyan test pattern against a cyan background 280. The black test pattern against a white background 210 includes black test pixels 215 printed at various laser power settings. The yellow test pattern against a white background 230 includes yellow test pixels 235 printed at various laser power settings. The magenta test pattern against a white background 250 includes magenta test pixels 255 printed at various laser power settings. The cyan test pattern against a white background 270 includes cyan test pixels 275 printed at various laser power settings.

The black test pattern against a black background 220, yellow test pattern against a yellow background 240, magenta test pattern against a magenta background 260, and cyan test pattern against a cyan background 280 include test pixels, such as the cyan test pixels 285. These test pixels are printed at various laser power settings.

The test pixels 215, 235, 255, 275, 285 may have different visibilities based on their backgrounds and the laser power level. For example, the black test pixels 215 may be visible to the unaided eye against a white background at a laser power of 20% or above, but difficult to see below a laser power of 5%, even with a planned image enhancement for detecting security markings. The yellow test pixels 235 may be visible to the unaided eye against a white background at a laser power of 35% or above, but difficult to see below a laser power of 15%, even with a planned image enhancement for detecting security markings. In contrast, the cyan test pixel 285 may be visible to the unaided eye against a cyan background if the laser power is below 85%, but difficult to see with magnification or enhancement above a laser power of 95%. In various examples, the cyan test pixel 285 printed against a non-white background may also have an upper limit. If the cyan background were printed with a laser power of 75%, the cyan test pixel 285 may be visible against the cyan background at a laser power below 60% or above 90%, while printing the cyan test pixel 285 at laser powers between 72% and 77% may be difficult to see, even with a planned image enhancement for detecting security markings.

In various examples, the backgrounds of the colored test patterns with non-white backgrounds 220, 240, 260, 280 may be printed at various shades of the background color to test changes in visibility for the cyan test pixels 285 across the different shades.

Determining the visibility of the test pixels 215, 235, 255, 275, 285 against the colored test patterns 210, 220, 230, 240, 250, 260, 270, 280 may allow selecting power levels to use in printing security pixels. When the background image is a mixed color, such as magenta and cyan, the security pixel may be printed in magenta and cyan, using the corresponding power level for printing a magenta or a cyan security pixel against a magenta or cyan background.

In various examples, the cyan test pixels 285 may include colors other than the background color. The black test pattern 220 may include test pixels that include cyan, yellow, or magenta. The black test pattern 220 may include test pixels that include multiple colors between cyan, yellow, magenta, and black printed at various power levels.

While black, cyan, yellow, and magenta are used as example colors, other colors may be used. For example, one printer may use the colors red, blue, green, and black.

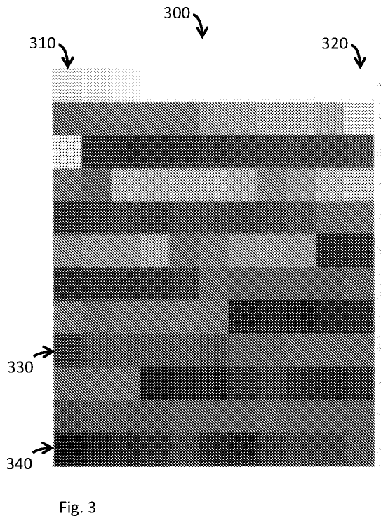

FIG. 3 shows a mixed color test pattern 300 in accordance with various examples. The mixed color test pattern 300 includes various test pattern blocks 310, 320, 330, 340 with different background colors. For example, test pattern block 310 may include a yellow background. Test pattern block 320 may include a white background. Test pattern block 330 may include a cyan background. Test pattern block 340 may include a black background. The test pattern blocks 310, 320, 330, 340 may include test pixels printed at various laser power levels. The test pixels may be printed using the same colors but with a modified laser power. The test pixels may modify the colors of the test pixels from the background, as well as modifying the laser power. Printing test pixels across a variety of mixed color pattern backgrounds, as opposed to against a pure color background, may result in determining that different laser power settings should be used when printing security pixels against a mixed color background. Rather than adjusting the laser power levels independently for a mixed color security pixel, the presence of other colors in the security pixel may affect the laser power level of a particular color. For example, in printing an orange security pixel using yellow and magenta, the adjustments to the laser power when printing yellow and the laser power when printing magenta may depend on the shade of orange. For some shades, the magenta laser power may change, while the yellow laser power is not modified. For some shades, the yellow laser power may change, while the magenta laser power is not modified. For some shades, both yellow and magenta laser powers may change, but by different amounts across the different shades. For some shades, cyan may be added when printing the security pixel.

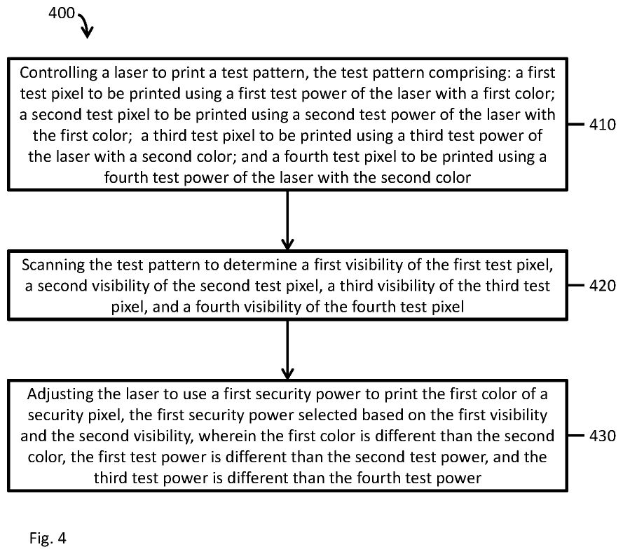

FIG. 4 shows a method 400 of printing a test pattern and adjusting a laser based on visibility of pixels in the test pattern in accordance with various examples. Method 400 includes controlling a laser to print a test pattern, the test pattern comprising: a first test pixel to be printed using a first test power of the laser with a first color; a second test pixel to be printed using a second test power of the laser with the first color; a third test pixel to be printed using a third test power of the laser with a second color; and a fourth test pixel to be printed using a fourth test power of the laser with the second color (410). Method 400 includes scanning the test pattern to determine a first visibility of the first test pixel, a second visibility of the second test pixel, a third visibility of the third test pixel, and a fourth visibility of the fourth test pixel (420). Method 400 includes adjusting the laser to use a first security power to print the first color of a security pixel, the first security power selected based on the first visibility and the second visibility, wherein the first color is different than the second color, the first test power is different than the second test power, and the third test power is different than the fourth test power (430).

A test pattern may be printed to determine laser powers to be used in printing security pixels. The test pattern may include multiple test pixels printed in various colors. The test pattern may be used as part of a self-test or self-calibration procedure and serve purposes beyond determining laser powers for printing security pixels. For example, the test pattern may include a black test pattern section, a yellow test pattern section, a magenta test pattern section, and a cyan test pattern section. The yellow test pattern section may include a section printing yellow test pixels at different power levels against a white background. Analyzing the test pixels may assist in determining a power level at which a yellow security pixel may be printed against a white background. The yellow test pattern may include a section printing yellow test pixels at different power levels against a yellow background. Analyzing these test pixels may assist in determining a power level at which a yellow security pixel may be printed, such as at a reduced laser power, causing it to be a lighter yellow against a background of yellow.

A single color may be selected for use when printing security pixels against white backgrounds. For example, yellow security pixels may be selected due to the difficulties the human eye may have with seeing the color yellow, especially a light yellow against a white background. In various examples, the other colors may still be tested against a white background to assist with scaling the laser power across different shades of colors. While printing a cyan security pixel against a cyan background may include reducing the laser power by 10% for a dark shade of cyan, the laser power may be adjusted by a different amount when printing against a lighter shade of cyan. The test pixels of cyan against a white background may be used in providing a scaling factor across different shades of cyan.

In various examples, the test pattern may include backgrounds of different darkness. Using a test pattern with various shades of cyan from light cyan to dark cyan may allow a better determination of laser powers, as it may allow use of a polynomial equation in determining an appropriate laser power, rather than a linear modification of the power level.

In various examples, the laser power in printing a security pixel may be increased when the background is a lighter shade and decreased when the background is a darker shade.

The test pattern may be scanned to determine visibilities of the test pixels. Some of the test pixels may be visible by the unaided eye. Some test pixels may not be visible to the unaided eye, but visible using image enhancement. Some test pixels may not be visible even when using a target magnification or image enhancement to be used in detecting security pixels. Laser powers for printing security pixels may be selected so that the security pixels are not visible to the unaided eye, but still visible using a planned method of image enhancement. Due to differences in eyesight, some security pixels may be visible to certain individuals, but such changes should be slight.

In various examples, printing and scanning the test pattern may be performed at different times. The test pattern may be printed and scanned during development of the printer, with the power levels for printing the security pixels stored in a memory on the printer. The power levels may be the same across that model of printer. The test pattern may be printed and scanned during a manufacturing test of the printer, with the power levels for printing the security pixels stored in a memory on the printer. The power levels may be different across the printers, even of the same model, but not change over time. The test pattern may be printed and scanned as part of a self-test or self-configuration. This may be performed as part of a manufacturing test or when authorized maintenance is performed on the printer, or a user may be able to initiate such an operation. The power levels may be different across printers of the same model and even different for the same printer across time. In various examples, the operation may be performed when replacing toner, as different toner may produce different visibilities at different power levels.

Based on the visibilities of the test pixels, the laser may be adjusted to use different security power levels when printing security pixels. The security power levels may be absolute values or modifications to the power level that would be used in printing the underlying pixel. For example, if the underlying pixel is a dark cyan, the security pixel may be printed at an 85% power level, or it may be printed at a power level 5% lower than what the dark cyan would be printed at, or it may be printed at 90% of what the dark cyan would be printed at. The laser power may be treated in terms of watts or another format in place of percentages.

In various examples, a security pixel may be printed in multiple colors. In printing the security pixel, the processor may treat the individual colors separately. For example, when printing a security pixel that includes magenta, the printer may base the power level on the visibility of the magenta test pixels against a magenta background and the amount of magenta in the background of the security pixel to be printed. The amount of cyan present in the background or the original pixel to be printed may be irrelevant to printing the magenta portion of the security pixel.

In various examples, in selecting the security power to use in printing a security pixel, a different laser power may be used than was used for the test pixels. For example, the processor may identify two test laser powers that are close to having the desired characteristics, but determine that a laser power between those two test laser powers should be used in printing security pixels. The processor may use a weighted average or other method of calculating an intermediate laser power to use in printing the security pixel.

In various examples, the test pixels may be printed using multiple colors. The test pixels may be printed using colors different than their backgrounds. For example, an orange security pixel combining magenta and yellow may work well against an orange background. For example, a green security pixel may work well against a background of cyan. The green security pixel may be printed using a laser power with yellow and a laser power with cyan.

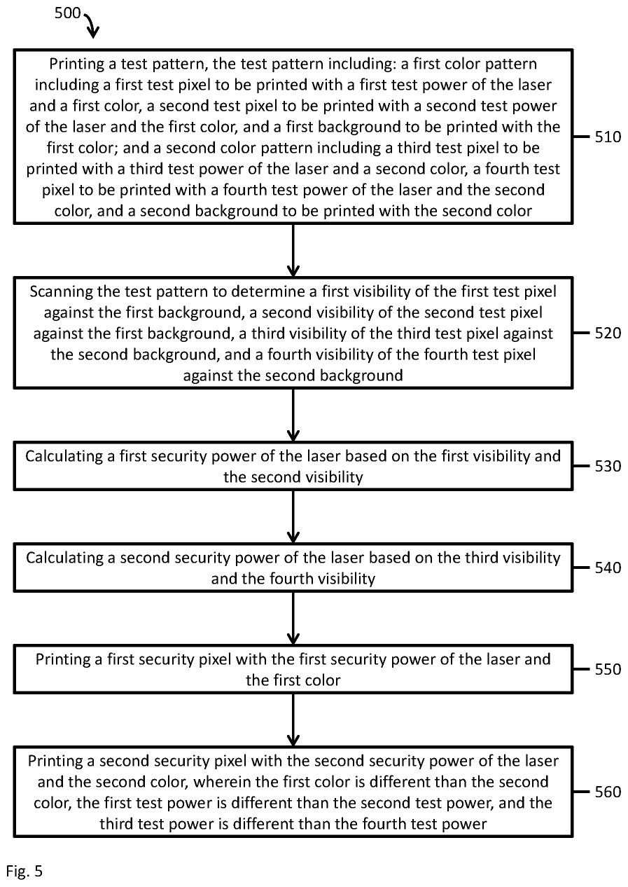

FIG. 5 shows a method 500 of printing a test pattern and calculating security powers of a laser to print security pixels in accordance with various examples. Method 500 includes printing a test pattern, the test pattern including: a first color pattern including a first test pixel to be printed with a first test power of the laser and a first color, a second test pixel to be printed with a second test power of the laser and the first color, and a first background to be printed with the first color; and a second color pattern including a third test pixel to be printed with a third test power of the laser and a second color, a fourth test pixel to be printed with a fourth test power of the laser and the second color, and a second background to be printed with the second color (510). Method 500 includes scanning the test pattern to determine a first visibility of the first test pixel against the first background, a second visibility of the second test pixel against the first background, a third visibility of the third test pixel against the second background, and a fourth visibility of the fourth test pixel against the second background (520). Method 500 includes calculating a first security power of the laser based on the first visibility and the second visibility (530). Method 500 includes calculating a second security power of the laser based on the third visibility and the fourth visibility (540). Method 500 includes printing a first security pixel with the first security power of the laser and the first color (550). Method 500 includes printing a second security pixel with the second security power of the laser and the second color, wherein the first color is different than the second color, the first test power is different than the second test power, and the third test power is different than the fourth test power (560).

The background used with test pixels may affect the visibility of the pixels. For example, a dark yellow test pixel may be visible to the unaided eye when printed against a white background, but not visible to the unaided eye when printed against a darker yellow background. In determining visibility of the test pixels, the background of the test pixels may also be analyzed.

In various examples, a security pixel may replace an input pixel in the underlying document or image to be printed. The security pixel may be based on the input pixel it is to replace. The security pixel may be printed using the same colors that would be used to print the input pixel, but the laser power used to print those colors may be modified to make the security pixel visible via image enhancement, but not visible to the unaided eye. The laser powers may also be based on nearby pixels. In various examples, a security pixel may replace the input pixel but discard any data from the input pixel and base the security pixel on the nearby pixels.

In various examples, the security power levels may differ based on the background. For example, one security pixel may be printed against a background of whitespace, while a second security pixel may be printed against a background of yellow. The processor may determine that a yellow security pixel be printed against both of the backgrounds, but choose different security power levels based on the background. The security pixel printed against the white background may use a lower laser power, while the security pixel printed against the yellow background may use a higher laser power.

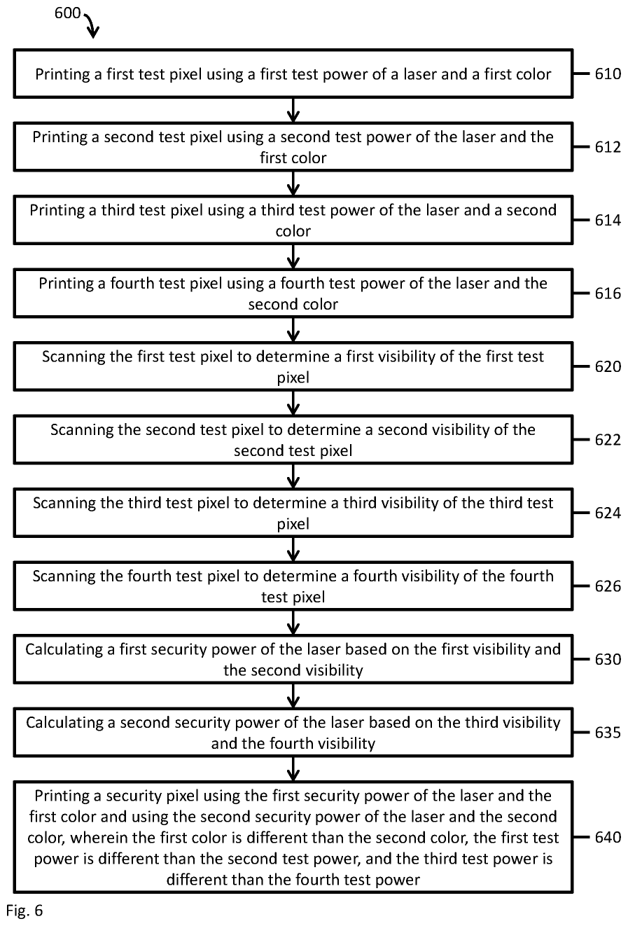

FIG. 6 shows a method 600 of printing test pixels and calculating security powers of a laser to print security pixels in accordance with various examples. Method 600 includes printing a first test pixel using a first test power of a laser and a first color (610). Method 600 includes printing a second test pixel using a second test power of the laser and the first color (612). Method 600 includes printing a third test pixel using a third test power of the laser and a second color (614). Method 600 includes printing a fourth test pixel using a fourth test power of the laser and the second color (616). Method 600 includes scanning the first test pixel to determine a first visibility of the first test pixel (620). Method 600 includes scanning the second test pixel to determine a second visibility of the second test pixel (622). Method 600 includes scanning the third test pixel to determine a third visibility of the third test pixel (624). Method 600 includes scanning the fourth test pixel to determine a fourth visibility of the fourth test pixel (626). Method 600 includes calculating a first security power of the laser based on the first visibility and the second visibility (630). Method 600 includes calculating a second security power of the laser based on the third visibility and the fourth visibility (635). Method 600 includes printing a security pixel using the first security power of the laser and the first color and using the second security power of the laser and the second color, wherein the first color is different than the second color, the first test power is different than the second test power, and the third test power is different than the fourth test power (640).

The security pixels may be used to form a security code. The security code may include an identification of the printer used to print the image or document. The security code may include a timestamp indicating a date or time the image or document was printed.

Printing different shades of colors may involve using different power levels. Thus, the laser power may change based on the underlying image to be printed, the color to be printed, and the adjustment to laser power to print the security pixel. In printing the test pixels, different laser powers may be used. Different laser powers may be used in printing backgrounds to the test pixels. Thus, multiple test pixels may be printed using a 10% laser power to capture the different colors that may be used for the pixel and the background. Testing across multiple backgrounds and multiple laser powers may allow more closely matching the colors of the test pixels to the background colors while still providing sufficient difference in color for the test pixel to be identified as security pixels.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A computer-readable medium to store machine-readable instructions that, when executed by a processor, cause the processor to:
control a laser to print a test pattern, the test pattern comprising:
a first test pixel to be printed using a first test power of the laser with a first color;
a second test pixel to be printed using a second test power of the laser with the first color;
a third test pixel to be printed using a third test power of the laser with a second color; and
a fourth test pixel to be printed using a fourth test power of the laser with the second color;
scan the test pattern to determine a first visibility of the first test pixel, a second visibility of the second test pixel, a third visibility of the third test pixel, and a fourth visibility of the fourth test pixel; and
adjust the laser to use a first security power to print the first color of a security pixel, the first security power selected based on the first visibility and the second visibility, wherein the first color is different than the second color, the first test power is different than the second test power, and the third test power is different than the fourth test power.

2. The computer-readable medium of claim 1, wherein execution of the machine-readable instructions by the processor causes the processor to adjust the laser to use a second security power to print the second color of the security pixel, the second security power based on the third visibility and the fourth visibility, wherein the first security power is different than the second security power.

3. The computer-readable medium of claim 2, wherein execution of the machine-readable instructions by the processor causes the processor to:
identify the first test power based on the first visibility;
identify the second test power based on the second visibility; and
calculate the first security power based on the first test power and the second test power.

4. The computer-readable medium of claim 1, wherein the first color includes cyan and the second color includes magenta.

5. The computer-readable medium of claim 1, wherein the first test pixel is to be printed using a fifth test power with the second color.

6. A computer-readable medium to store machine-readable instructions that, when executed by a processor, cause the processor to:
print a test pattern, the test pattern including:
a first color pattern including a first test pixel to be printed with a first test power of the laser and a first color, a second test pixel to be printed with a second test power of the laser and the first color, and a first background to be printed with the first color; and
a second color pattern including a third test pixel to be printed with a third test power of the laser and a second color, a fourth test pixel to be printed with a fourth test power of the laser and the second color, and a second background to be printed with the second color;
scan the test pattern to determine a first visibility of the first test pixel against the first background, a second visibility of the second test pixel against the first background, a third visibility of the third test pixel against the second background, and a fourth visibility of the fourth test pixel against the second background;
calculate a first security power of the laser based on the first visibility and the second visibility;
calculate a second security power of the laser based on the third visibility and the fourth visibility;
print a first security pixel with the first security power of the laser and the first color; and
print a second security pixel with the second security power of the laser and the second color, wherein the first color is different than the second color, the first test power is different than the second test power, and the third test power is different than the fourth test power.

7. The computer-readable medium of claim 6, wherein the first color includes yellow and the second color includes black.

8. The computer-readable medium of claim 6, wherein execution of the machine-readable instructions by the processor causes the processor to print an image based on an input image, the input image including an input pixel, the first security power being based on the input pixel, and the first security pixel being printed as part of the image in place of the input pixel.

9. The computer-readable medium of claim 8, wherein execution of the machine-readable instructions by the processor causes the processor to print a third security pixel as part of the image in place of a second input pixel of the input image, the second input pixel representing whitespace, and the third security pixel to be printed using a third security power and the first color.

10. The computer-readable medium of claim 8, wherein the first security power is based on additional input pixels in the input image, the additional input pixels being adjacent to the input pixel.

11. A method comprising:
printing a first test pixel using a first test power of a laser and a first color;
printing a second test pixel using a second test power of the laser and the first color;
printing a third test pixel using a third test power of the laser and a second color;
printing a fourth test pixel using a fourth test power of the laser and the second color;
scanning the first test pixel to determine a first visibility of the first test pixel;
scanning the second test pixel to determine a second visibility of the second test pixel;
scanning the third test pixel to determine a third visibility of the third test pixel;
scanning the fourth test pixel to determine a fourth visibility of the fourth test pixel;
calculating a first security power of the laser based on the first visibility and the second visibility;
calculating a second security power of the laser based on the third visibility and the fourth visibility; and
printing a security pixel using the first security power of the laser and the first color and using the second security power of the laser and the second color, wherein the first color is different than the second color, the first test power is different than the second test power, and the third test power is different than the fourth test power.

12. The method of claim 11 comprising printing a background using a background test power of the laser and the first color, the background surrounding the first test pixel and the second test pixel.

13. The method of claim 11 comprising printing a security code comprising the security pixel, the security code including an identification of a printer, the printer comprising the laser.

14. The method of claim 13, wherein the security code comprises a timestamp.

15. The method of claim 11 comprising printing an image, the image comprising the security pixel.
